(19) United States
(12) Patent Application Publication
(10) Pub. No.: US 2003/0091040 A1
(43) Pub. Date: May 15, 2003

(54) Digital signal processor and method of transferring program to the same

(75) Inventor: Yutaka Furukawa, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/294,247

(22) Filed: Nov. 14, 2002

(30) Foreign Application Priority Data
Nov. 15, 2001 (JP) 2001-349941

(51) Int. Cl. H04L 12/50

(52) U.S. Cl. 370/375

(57) ABSTRACT

A digital signal processor includes a plurality of processor-cores, and a controller which divides a program into a plurality of sub-programs, and transfers each of the sub-programs to each of the processor-cores one by one at a predetermined time-interval. The digital signal processor may further include a direct access memory (DMA) controller which controls data transfer to the processor-cores, in which case, each of the processor-cores includes a memory through which each of the sub-programs is received, and the direct access memory controller transfers each of the sub-programs to the memory in accordance with a control carried out by the controller.

### BACKGROUND OF THE INVENTION

1. Field of the Invention

The invention relates to program transfer in a processor, and more particularly to a processor including a plurality of processor-cores each having an instruction memory to which a program is to be transferred from an external memory, and further to a method of transferring a program to a processor.

2. Description of the Related Art

In a conventional multi-processor system including a plurality of central processing units as processors, before the system starts its operation, a program is initially transferred or loaded to a local memory in each of the central processing units from an external memory making communication with all of the central processing units.

However, the conventional multi-processor system is accompanied with a problem as follows.

In the conventional multi-processor system, a program is transferred to each of the central processing units in order. Accordingly, even if program transfer has been completed in some central processing units, these some central processing units remain in a highly loaded condition, until program transfer is completed in all of the central processing units. In other words, a central processing unit or central processing units to which a program has been already transferred has (have) to be kept in a highly loaded condition for a long period of time.

In order to solve the problem mentioned above, Japanese Unexamined Patent Publication 6-348671 (A) has suggested a method of transferring a program which method can avoid a particular central processing unit(s) from being kept in a highly loaded condition.

FIG. 1 is a block diagram of a multi-processor system disclosed in the above-mentioned Publication.

The illustrated multi-processor system is comprised of first to third central processing units (CPUs) 51-1 to 51-3, a bus arbiter 50, an external storage unit 55, a common memory 56, and a common bus 54 through which each of the first to third central processing units 51-1 to 51-3 makes communication with the external storage unit 55 and the common memory 56.

Each of the first to third central processing units 51-1 to 51-3 includes first to third local memories 52-1 to 52-3, and first to third registers 53-1 to 53-3, respectively.

The external storage unit 55 is comprised of first to third control registers 57-1 to 57-3, an arranging circuit 58, a transfer circuit 59, and a random access memory (RAM) 60 storing a program therein.

The bus arbiter 50 connects each of the first to third central processing units 51-1 to 51-3 to the transfer circuit 59.

The first to third control registers 57-1 to 57-3 are associated with the first to third central processing units 51-1 to 51-3, respectively, and stores addresses the first to third local memories 52-1 to 52-3, an address of the random access memory 60, and a predetermined volume of the program to be transferred to the first to third central processing units 51-1 to 51-3.

The arranging circuit 58 determines one of the first to third central processing units 51-1 to 51-3 to which the program stored in the random access memory 60 is to be transferred such that the program is uniformly transferred by the predetermined volume to the first to third central processing units 51-1 to 51-3, if the predetermined volume stored in the first to third control registers 57-1 to 57-3 is not set equal to zero.

The transfer circuit 59 acquires a right of using the common bus 54, and then, transfers the program from the random access memory 60 to one of the first to third local memories 52-1 to 52-3 of the first to third central processing units 51-1 to 51-3 in accordance with the determination of the arranging circuit 58, through the use of the local memory addresses and the random access memory addresses both stored in one of the first to third registers 53-1 to 53-3 associated with one of the first to third central processing units 51-1 to 51-3 determined by the arranging circuit 58.

The transfer circuit 59 further updates what is stored in the first to third control registers 57-1 to 57-3.

When the multi-processor system starts its operation, each of the first to third central processing units 51-1 to 51-3 acquires a right of using the common bus 54, and then, sets addresses of the first to third local memories 52-1 to 52-3, an address of the random access memory 60, and a predetermined volume by which the program is successively transferred, in the associated first to third central processing units 51-1 to 51-3.

In operation, when the multi-processor system starts its operation, the program stored in the random access memory 60 is transferred successively every the predetermined volume to the first to third local memories 52-1 to 52-3 of the first to third central processing units 51-1 to 51-3.

In the multi-processor system, the first to third local memories 52-1 to 52-3 of the first to third central processing units 51-1 to 51-3 is required to have a large capacity for receiving the program from the external storage unit 55, and it is necessary for the program to be stored in all of the first to third local memories 52-1 to 52-3.

The multi-processor system illustrated in FIG. 1 is accompanied with the following problems.

First, a central processing unit(s), to which the program has been already transferred, has to be kept in a stand-by condition, in other words, in a highly loaded condition, until the program is transferred to all of the first to third central processing units 51-1 to 51-3.

Second, when a program is transferred to a plurality of processor-cores each including an instruction memory and a data memory, from an external memory in the multi-processor system illustrated in FIG. 1, the program is transferred to the processor-cores in parallel in order to prevent concentration of a load to a particular processor-cores(s). However, such parallel transfer to the processor-cores is effective only when a memory in each of the processor-cores has a large capacity, and when the program is stored in all of the processor-cores. If a memory in each of the processor-cores had a small capacity, it would be impossible to store the program into the memory, resulting interruption in the program transfer.

Japanese Unexamined Patent Publication 6-259260 (A) has suggested a program download system which downloads a program to an apparatus to operate the apparatus, from a processor having a preliminary storage unit. The program is divided into a plurality of sub-programs in the processor, and then, is downloaded into the apparatus one by one of the sub-programs. Each time the sub-program is downloaded, it is checked whether the sub-program is downloaded properly or not. If the sub-program is improperly downloaded to the apparatus, the sub-program is downloaded again to the apparatus. If the sub-program is properly downloaded to the apparatus, a next sub-program is downloaded to the apparatus.

Japanese Unexamined Patent Publication 2000-242611 (A) has suggested a multi-processor system which can operate only when programs in a plurality of processors are simultaneously booted. In the multi-processor system, an instruction of starting booting a program is transmitted simultaneously to the processors. On receipt of the instruction, the programs are booted in the processors.

Japanese Unexamined Patent Publication 2001-5789 (A) has suggested a multi-core digital signal processing circuit including a plurality of digital signal processor-cores each processing a digital signal, a read only memory (ROM) storing a program therein for operating the digital signal processor-cores, a system clock which operates the digital signal processor-cores, and a program counter which is operated in accordance with a program counter clock having a frequency obtained by multiplying an operation frequency of the system clock by the number of the digital signal processor-cores, and reads program data out of the read only memory.

Japanese Unexamined Patent Publication 2001-209575 (A) has suggested a signal processor including at least two digital signal processing circuit blocks electrically connected to a first system bus. Each of the digital signal processing circuit blocks is comprised of a local memory storing a program therein, a digital signal processor which reads the program out of the local memory, and an interface circuit which writes data transferred on the first system bus, into the local memory. The local memory is mapped to regions having the same address, on the first system bus.

However, the above-mentioned problems remain unsolved even in the Publications mentioned above.

### SUMMARY OF THE INVENTION

In view of the above-mentioned problems in the conventional multi-processor system, it is an object of the present invention to provide a processor which is capable of smoothly transferring a program to each of processor-cores without pause, even if a memory in each of the processor-cores to which the program is to be transferred had a small capacity.

It is also an object of the present invention to provide a method of transferring a program to each of processor-cores, which method is capable of doing the same.

In one aspect of the present invention, there is provided a processor including (a) a plurality of processor-cores, and (b) a controller which divides a program into a plurality of sub-programs, and transfers each of the sub-programs to each of the processor-cores one by one at a predetermined time-interval.

The processor may further include a direct access memory (DMA) controller which controls data transfer to the processor-cores, and wherein each of the processor-cores includes a memory through which each of the sub-programs is received, and the direct access memory controller transfers each of the sub-programs to the memory in accordance with a control carried out by the controller.

The processor may further include (a) a first interface which makes communication with an external time division multiplexer (TDM), (b) a second interface which makes communication with an external memory, and (c) a third interface which makes communication with an external host central processing unit.

The processor may further include a program-receiver to which the program is transferred from the external memory.

For instance, the processor is comprised as a data signal processor (DSP).

For instance, the program to be processed by the processor is a program for processing aural signals or a program for processing image signals.

It is preferable that the controller transfers each of the sub-programs to each of the processor-cores one by one at the same time-interval.

In another aspect of the present invention, there is provided a method of transferring a program into a plurality of processor-cores in a processor, includes the steps of (a) dividing the program into a plurality of sub-programs, and (b) transferring each of the sub-programs to each of the processor-cores one by one at a predetermined time-interval.

The method may further include the step of receiving the program from an external memory.

It is preferable that each of the sub-programs is transferred to each of the processor-cores one by one at the same time-interval in the step (b).

In still another aspect of the present invention, there is provided a program for causing a computer to carry out a method of transferring a program into a plurality of processor-cores in a processor, the method including the steps of (a) dividing the program into a plurality of sub-programs, and (b) transferring each of the sub-programs to each of the processor-cores one by one at a predetermined time-interval.

There is further provided a program for causing a computer as a processor, the processor including (a) a plurality of processor-cores, and (b) a controller which divides a program into a plurality of sub-programs, and transfers each of the sub-programs to each of the processor-cores one by one at a predetermined time-interval.

The advantages obtained by the aforementioned present invention will be described hereinbelow.

In the present invention, a program is divided into a plurality of sub-programs, and the sub-programs are transferred to each of the processor-cores one by one in succession at a predetermined time-interval. Hence, the program can be smoothly transferred to each of the processor-cores without pause, even if a memory in each of the processor-cores had a small capacity.

For instance, even if a memory in each of the processor-cores had a small capacity, it would be possible to transfer a program to each of the processor-cores from an external memory without pause.

Second, since the processor is no longer necessary to include a memory having a large capacity, the processor in the form of a chip can be fabricated smaller.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a conventional processor.

FIG. 2 is a block diagram of a processor in accordance with the first embodiment of the present invention.

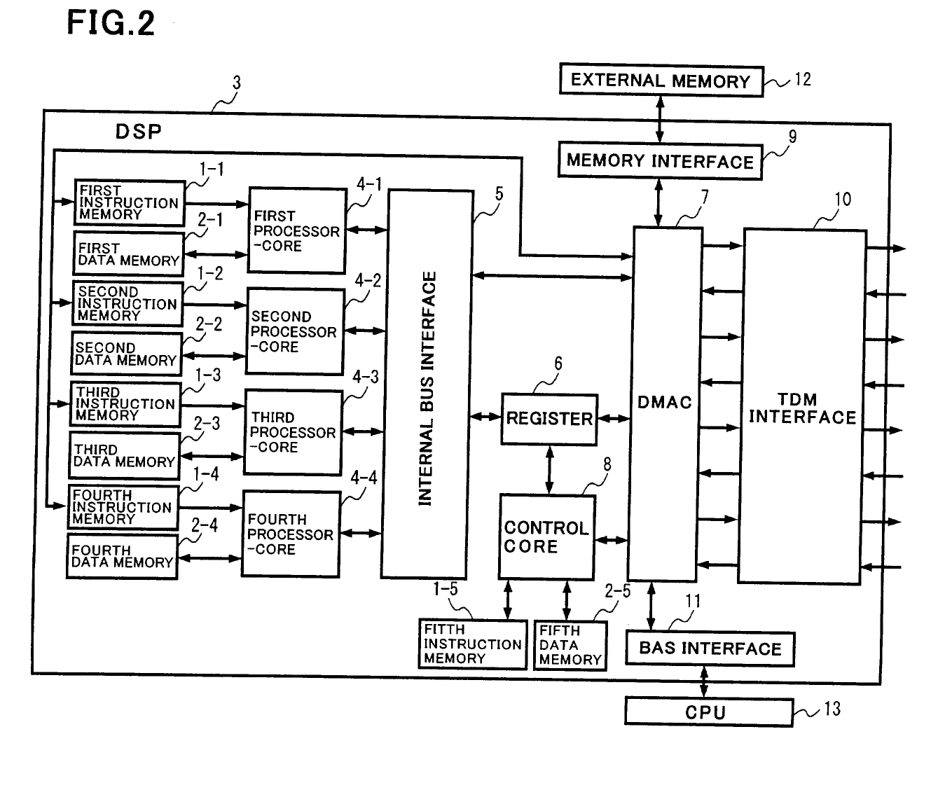

FIG. 3 is a block diagram of a time division multiplexer interface which is a part of the processor illustrated in FIG. 2.

FIG. 4 is a timing chart of program transfer to be carried out by the processor in accordance with the first embodiment.

FIG. 5 is a timing chart of program transfer to be carried out by the processor in accordance with the first embodiment.

### DESCRIPTION OF THE PREFERRED EMBODIMENTS

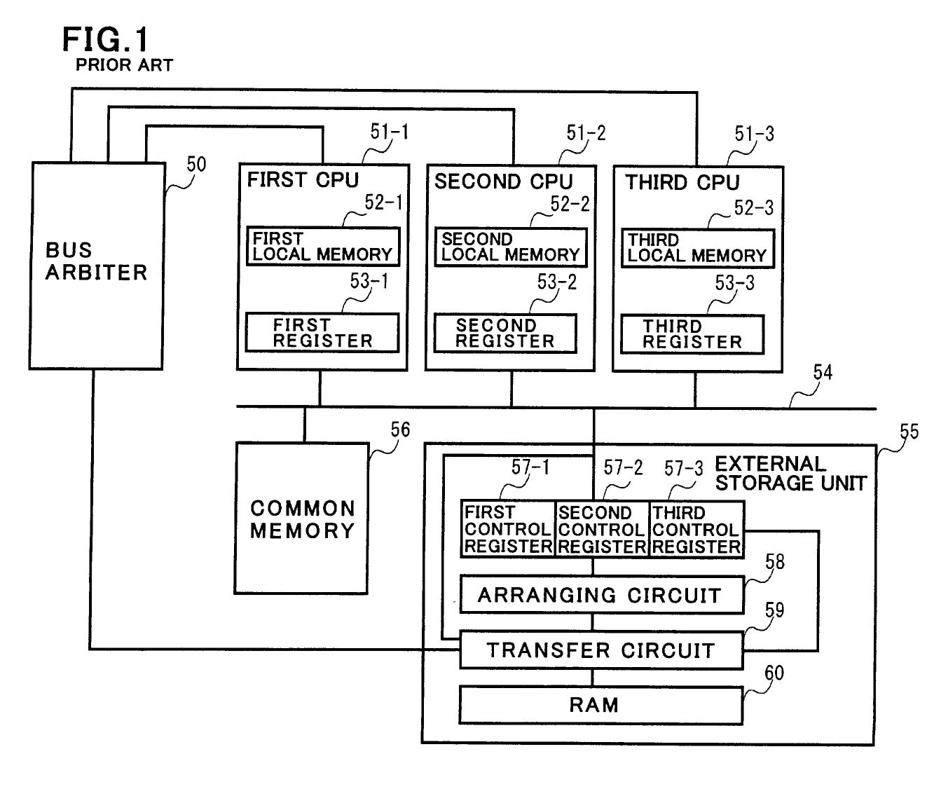

FIG. 1 is a block diagram of a processor in accordance with the first embodiment of the present invention.

The processor 3 in accordance with the first embodiment is constructed as a digital signal processor (DSP) which is a micro-processor used only for processing digital signals.

The digital signal processor 3 is comprised of first to fourth processor-cores 4-1 to 4-4, first to fifth instruction memories 1-1 to 1-5, first to fifth data memories 2-1 to 2-5, a control core 8, a direct memory access controller (DMAC) 7, an internal bus interface 5, a time division multiplexer (TDM) interface 10, a register 6, a memory interface 9, and a bus interface 11.

The digital signal processor 3 is designed to be able to make communication with an external memory 12 and a central processing unit (CPU) 13.

The direct memory access controller (DMAC) 7 is designed to make communication with the time division multiplexer interface 10, the memory interface 9, the register 6, the control core 8, the bus interface 11 and the first to fourth instruction memories 1-1 to 1-4.

The internal bus interface 5 is designed to make communication with the first to fourth processor-cores 4-1 to 4-4, the register 6, and the direct memory access controller (DMAC) 7.

The memory interface 9 acts as an interface between the direct memory access controller (DMAC) 7 and the external memory 12 located outside the digital signal processor 3.

The control core 8 is designed to make communication with the direct memory access controller (DMAC) 7, the register 6, the fifth instruction memory 1-5, and the fifth data memory 2-5.

The bus interface 11 acts as an interface between the direct memory access controller (DMAC) 7 and the central processing unit 13 located outside the digital signal processor 3.

Each of the first to fourth processor-cores 4-1 to 4-4 processes aural signals, for instance, encode and decode aural signals in accordance with GSM-AMR, G. 729A, for instance. Each of the first to fourth processor-cores 4-1 to 4-4 is associated with the first to fourth instruction memories 1-1 to 1-4 and the first to fourth data memories 2-1 to 2-4, respectively. Each of the first to fourth instruction memories 1-1 to 1-4 receives a program transferred from the direct memory access controller (DMAC) 7 to each of the first to fourth processor-cores 4-1 to 4-4.

The internal bus interface 5 acts as an interface between the register 6 and the first to fourth processor-cores 4-1 to 4-4 and further between the direct memory access controller (DMAC) 7 and the first to fourth processor-cores 4-1 to 4-4.

The register 6 receives commands from the central processing unit 13 through the control core 8, and transfers the received commands to the first to fourth processor-cores 4-1 to 4-4. To this end, after the commands have been written into the register 6, the register 6 informs one of the first to fourth processor-cores 4-1 to 4-4 of the commands by conducting interruption (INT).

The direct memory access controller (DMAC) 7 controls the memory interface 9, the bus interface 11, the time division multiplexer interface 10 and the register 6 in operation. The direct memory access controller (DMAC) 7 transfers data between the first to fourth instruction memories 1-1 to 1-4 and the external memory 12, between the time division multiplexer interface 10 and the external memory 12, and between the central processing unit 13 and the external memory 12.

The direct memory access controller (DMAC) 7 has a function of arranging data transfer. Specifically, the direct memory access controller (DMAC) 7 transmits address data to and receives address data from other parts of the digital signal processor 3, based on DMA transfer data stored in the register 6, ensuring smooth data transfer in compliance with a request transmitted from the other parts.

The bus interface 11 receives commands from the central processing units 13, reads a service program out of the central processing unit 13, and acts as an interface for booting a program.

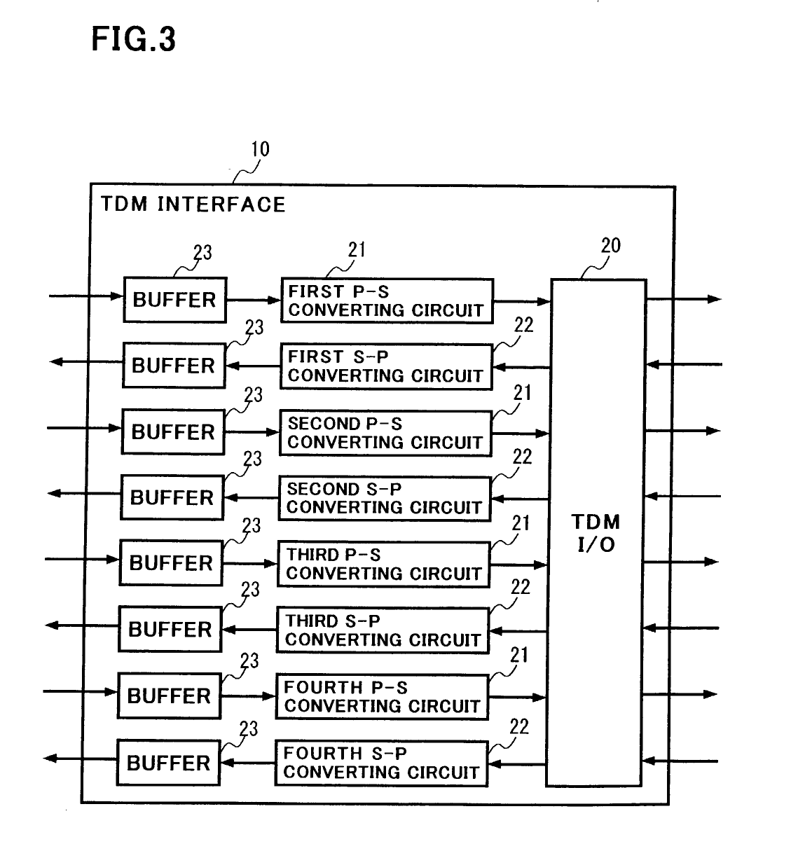

FIG. 3 is a block diagram of the time division multiplexer interface 10.

As illustrated in FIG. 3, the time division multiplexer interface 10 is comprised of a time division multiplexer I/O 20, first to fourth parallel-serial converting circuits 21, first to fourth serial-parallel converting circuits 22 and eight buffers 23.

The time division multiplexer interface 10 acts as an interface between a time division multiplexer (not illustrated) and the direct memory access controller (DMAC) 7. For instance, the time division multiplexer interface 10 transmits and receives data used for encoding aural signals.

In operation of receiving data, the time division multiplexer interface 10 receives data at the time division multiplexer I/O 20 from an external hardware, converts the received data into a parallel form from a serial form in the first to fourth serial-parallel converting circuits 22, and stores the data into the buffers 23. The data having been stored in the buffers 23 is transferred in DMA transmission into a predetermined area in the external memory 12.

In operation of transmitting data, the time division multiplexer interface 10 receives data in DMA transmission from the external memory 12, and writes the received data into the buffers 23. The data stored in the buffers 23 is converted into a serial form from a parallel form in the first to fourth parallel-serial converting circuits 21, and then, is transmitted to an external hardware through the time division multiplexer I/O 20.

The memory interface 9 acts as an interface between the direct memory access controller (DMAC) 7 and the external memory 12 in which a program is stored and data to be transmitted to the digital signal processor 3 and having been received from the digital signal processor 3 is temporarily stored. The memory interface 9 further controls the external memory 12.

The external memory 12 stores a plurality of programs and data to be used by the first to fourth processor-cores 4-1 to 4-4 to encode and decode aural signals in accordance with GSM-AMR, G. 729A, for instance. That is, the external memory 12 is commonly used by the first to fourth processor-cores 4-1 to 4-4.

The internal bus interface 5 acts as an interface between the register 6 and the first to fourth processor-cores 4-1 to 4-4 and between the memory interface 9 and the first to fourth processor-cores 4-1 to 4-4. When data is to be written into the memory interface 9, the internal bus interface 5 temporarily stores data therein, and then, transmits the data to the memory interface 9. When data is read out of the memory interface 9, the internal bus interface 5 stores all of the data therein, considering a case where the first to fourth processor-cores 4-1 to 4-4 are not be able to receive data in succession.

The control core 8 determines a timing at which data is transferred to the first to fourth processor-cores 4-1 to 4-4. The control core 8 is associated with the fifth instruction memory 1-5 and the fifth data memory 2-5.

The control core 8 receives commands from the central processing unit 13 through the register 6, analyzes the received commands, and then, transmits the analyzed commands to the first to fourth processor-cores 4-1 to 4-4 through the register 6. The control core 8 further receives notification of completion of processing and a request of conducting interruption through the register 6. Specifically, the control core 8 administrates data indicative of which one of the first to fourth processor-cores 4-1 to 4-4 is vacant and data indicative of which one of the first to fourth processor-cores 4-1 to 4-4 is in a stand-by condition, and determines a channel to which encoding is applied, in the first to fourth processor-cores 4-1 to 4-4.

As is obvious to those skilled in the art in view of the explanation having been made so far, it is quite important to control the control core 8 at a proper timing in the digital signal processor 3 in accordance with the first embodiment.

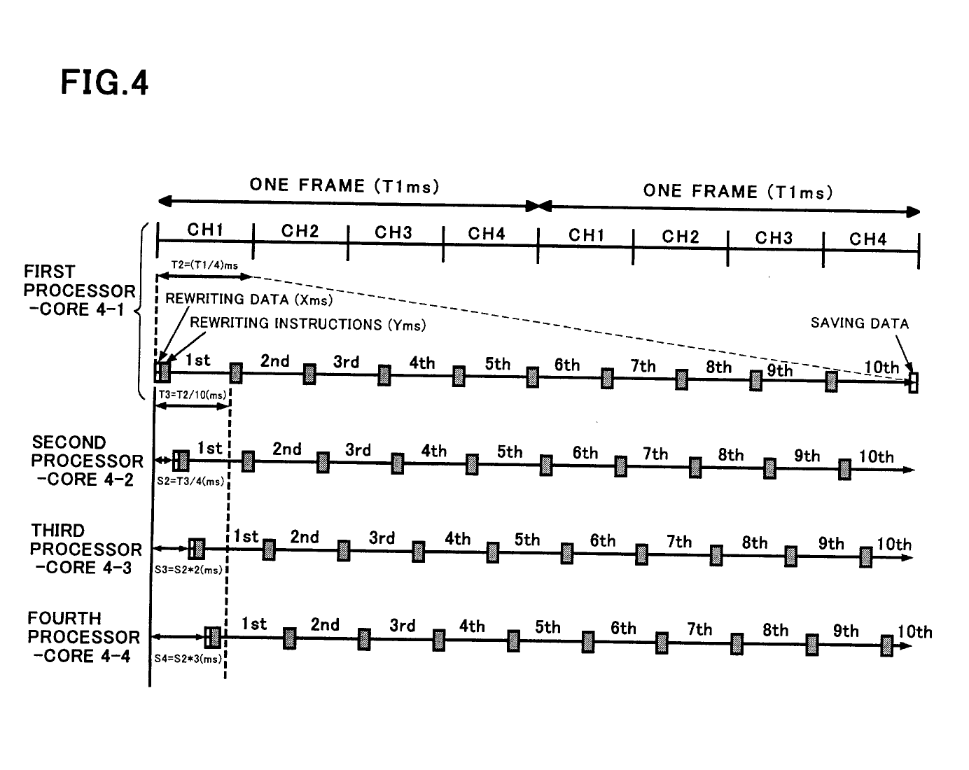

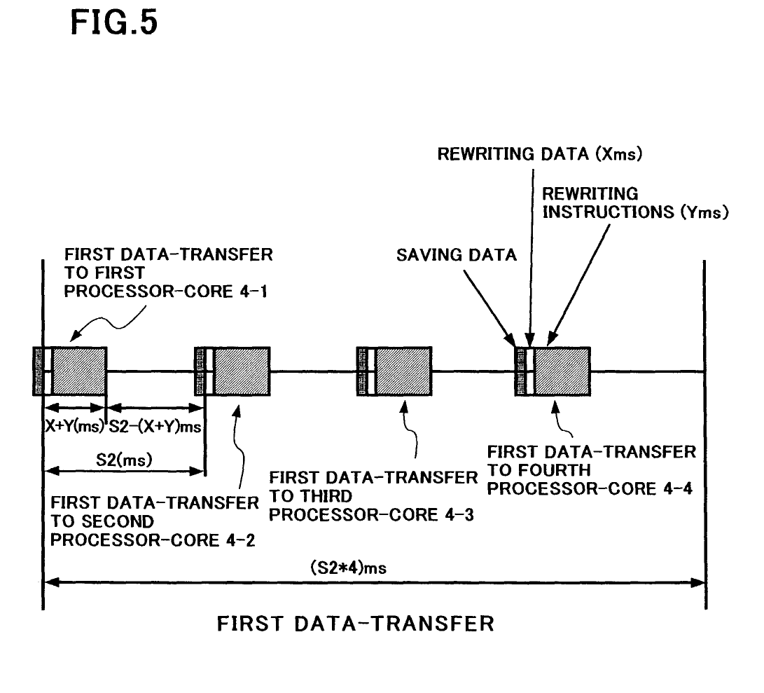

FIGS. 4 and 5 are timing charts of program transfer to be carried out by the digital signal processor 3. Specifically, FIG. 4 is a timing chart of program transfer between the external memory 12 and the first to fourth processor-cores 4-1 to 4-4. FIG. 5 shows the first program-transfer to the first to fourth processor-cores 4-1 to 4-4 in more detail among program-transfers illustrated in FIG. 4.

In FIGS. 4 and 5, data transfer between the time division multiplexer interface 10 and the external memory 12, and program booting between the central processing unit 13 and the external memory 12 are not illustrated. A program to be transmitted to the first to fourth processor-cores 4-1 to 4-4 is comprised of, for instance, a program for processing aural signals or image signals.

FIGS. 4 and 5 show a first example where each of the first to fourth processor-cores 4-1 to 4-4 processes data in four (4) channels, a program is divided into ten (10) sub-programs, and the digital signal processor 3 processes data in sixteen (16) channels.

Herein, one frame time is expressed as T1 (ms). In the first example, since data is processed in four channels in one frame time T1 (ms), a period of time T2 (ms) to process data in one channel is equal to a quarter of T1.

T2=T1/4(ms)

In the first example, data is transferred ten times per a channel. Hence, a period of time T3 necessary for carrying out one data-transfer is equal to T2/10 (ms).

T3=T2/10(ms)=T1/40(ms)

Accordingly, the first to fourth processor-cores 4-1 to 4-4 are controlled as follows in order to smoothly transfer data to each of the first to fourth processor-cores 4-1 to 4-4.

It is assumed herein data is transferred first to the first processor-core 4-1, secondly to the second processor-core 4-2, thirdly to the third processor-core 4-3, and finally to the fourth processor-core 4-4. It is also assumed that if data-transfer to the first processor-core 4-1 starts at T=0, data-transfer to the second to fourth processor-cores 4-2 to 4-4 start at T=S2, T=S3 and T=S4 (ms), respectively.

Thus, the second processor-core 4-2 starts receiving data in S2 (ms) after the first processor-core 4-1 has started receiving data.

S2=T3/4=T2/40(ms)=T1/160(ms)

The third processor-core 4-3 starts receiving data in S3 (ms) after the first processor-core 4-1 has started receiving data.

S3=S2×2=2×T3/4=T2/20(ms)=T1/80(ms)

The fourth processor-core 4-4 starts receiving data in S4 (ms) after the first processor-core 4-1 has started receiving data.

S4=S2×3=3×T3/4=3×T2/40(ms)=3×T1/160(ms)

In a period of time T3 (ms) assigned for carrying out data-transfer once, the first data-transfer to the first to fourth processor-cores 4-1 to 4-4 is completed.

The second or later data-transfer is carried out in the same way as the first data-transfer.

By repeating such data-transfer as mentioned above ten times, data-transfer to the first to fourth processor-cores 4-1 to 4-4 is completed in the first channel.

Data-transfer in the second to fourth channels is carried out in the same way as the data-transfer in the first channel.

By transferring data to the first to fourth processor-cores 4-1 to 4-4 in four channels, data-transfer in one frame is completed.

In accordance with the first embodiment, a program is first divided into a plurality of sub-programs, and the sub-programs are transferred to each of the first to fourth processor-cores 4-1 to 4-4 one by one in succession at the predetermined time-interval S2. Hence, the program can be smoothly transferred to each of the first to fourth processor-cores 4-1 to 4-4 without pause, even if a memory in each of the first to fourth processor-cores 4-1 to 4-4 had a small capacity.

Though it is assumed in the above-mentioned example that the number of the processor-cores is four (4), the number of channels is four (4), and the number of dividing a program into sub-programs or the number of carrying out data-transfer is ten (10), the numbers are not to be limited to those numbers.

Hereinbelow is explained a second example where the digital signal processor 3 includes A processor-cores, sub-programs are transferred to the A processor-cores in B channels, and a program is divided into C sub-programs.

Herein, one frame time is expressed as T1 (ms). In the second example, since data is processed in B channels in one frame time T1 (ms), a period of time T2 (ms) to process data in one channel is equal to T1/B.

T2=T1/B(ms)

In the second example, data is transferred C times per a channel. Hence, a period of time T3 necessary for carrying out one data-transfer is equal to T2/C (ms).

T3=T2/C(ms)=T1/BC(ms)

Accordingly, the A processor-cores are controlled as follows in order to smoothly transfer data to each of the A processor-cores.

It is assumed herein data is transferred first to the first processor-core, secondly to the second processor-core, thirdly to the third processor-core, - - - , and finally to the A-th processor-core. It is also assumed that if data-transfer to the first processor-core starts at T=0, data-transfer to the second to A-th processor-cores start at T=S2 to T=SA (ms), respectively.

Thus, the second processor-core starts receiving data in S2 (ms) after the first processor-core has started receiving data.

S2=T3/A=T2/CA(ms)=T1/BCA(ms)

The third processor-core starts receiving data in S3 (ms) after the first processor-core has started receiving data.

S3=S2×2=2×T3/S=2×T2/CA(ms)=2×T1/BCA(ms)

The A-th processor-core starts receiving data in SA (ms) after the first processor-core 4-1 has started receiving data.

SA=S2×(A−1)=(A−1)×T3/S=(A−1)×T2/CA(ms)=(A−1)×T1/BCA(ms)

In a period of time T3 (ms) assigned for carrying out data-transfer once, the first data-transfer to the first to A-th processor-cores is completed.

The second or later data-transfer is carried out in the same way as the first data-transfer.

By repeating such data-transfer as mentioned above C times, data-transfer to the first to A-th processor-cores is completed in the first channel.

Data-transfer in the second to B-th channels is carried out in the same way as the data-transfer in the first channel.

By transferring data to the first to A-th processor-cores in B channels, data-transfer in one frame is completed.

In accordance with the second embodiment, a program is first divided into a plurality of sub-programs, and the sub-programs are transferred to each of the first to A-th processor-cores one by one in succession at the predetermined time-interval S2. Hence, the program can be smoothly transferred to each of the first to A-th processor-cores without pause, even if a memory in each of the first to A-th processor-cores had a small capacity.

As having been explained so far, in the above-mentioned digital signal processor, a program is divided into a plurality of sub-programs, and the sub-programs are transferred to each of the processor-cores one by one in succession in accordance with the control carried out by the control core 8. Each of the processor-cores receives the sub-programs at a predetermined time-interval.

In addition, since the sub-programs are transferred to the processor-cores one by one, it would be possible to efficiently and smoothly transfer a program to each of the processor-cores. Accordingly, the digital signal processor in accordance with the first embodiment is no longer accompanied with the problem that a processor-core or processor-cores to which a program has been already transferred has(have) to be kept in a stand-by condition or in a highly loaded condition until a program is transferred to all of the processor-cores, unlike the conventional digital signal processor.

In addition, since the sub-programs are transferred to the processor-cores one by one, the program can be smoothly transferred to each of the processor-cores without pause, even if a memory in each of the processor-cores had a small capacity.

Though the sub-programs are transferred to each of the first to fourth processor-cores 4-1 to 4-4 at the constant time-interval S2 (ms) in the above-mentioned first embodiment, it is not always necessary to transfer the sub-programs at a constant time-interval. The sub-programs may be transferred to each of the first to fourth processor-cores 4-1 to 4-4 at a non-constant time-interval.

The digital signal processor 3 has such a structure as mentioned above, and operates in such a manner as mentioned above.

The digital signal processor 3 may be accomplished by an apparatus such as a personal computer or a work station, and a program to carry out the above-mentioned control. Such a program may be presented through a recording medium readable by a computer. The program is read out into an apparatus when the apparatus starts its operation. By controlling an operation of the apparatus, the parts constituting the digital signal processor 3, such as the internal bus control 5, the register 6, the control core 8, the direct memory access controller (DMAC) 7, the time division multiplexer interface 10, the memory interface 9 and the bus interface 11, can be accomplished in the apparatus. The first to fourth processor-cores 4-1 to 4-4, the first to fourth instruction memories 1-1 to 1-4, the first to fourth data memories 2-1 to 2-4, the fifth instruction memory 1-5, and the fifth data memory 2-5 can be accomplished by a storage device of the apparatus, such as a magnetic disc.

The control of data transfer having been mentioned so far may be accomplished as a program including various commands, and be presented through a recording medium readable by a computer.

In the specification, the term “recording medium” means any medium which can record data therein.

The term “recording medium” includes, for instance, a disk-shaped recorder such as CD-ROM (Compact Disk-ROM) or PD, a magnetic tape, MO (Magneto Optical Disk), DVD-ROM (Digital Video Disk-Read Only Memory), DVD-RAM (Digital Video Disk-Random Access Memory), a floppy disk, a memory chip such as RAM (Random Access Memory) or ROM (Read Only Memory), EPROM (Erasable Programmable Read Only Memory), EEPROM (Electrically Erasable Programmable Read Only Memory), smart media (Registered Trade Mark), a flush memory, a rewritable card-type ROM such as a compact flush card, a hard disk, and any other suitable means for storing a program therein.

A recording medium storing a program for accomplishing the above-mentioned apparatus may be accomplished by programming functions of the above-mentioned apparatuses with a programming language readable by a computer, and recording the program in a recording medium such as mentioned above.

A hard disc equipped in a server may be employed as a recording medium. It is also possible to accomplish the recording medium in accordance with the present invention by storing the above-mentioned computer program in such a recording medium as mentioned above, and reading the computer program by other computers through a network.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2001-349941 filed on Nov. 15, 2001 including specification, claims, drawings and summary is incorporated herein by reference in its entirety.

What is claimed is:

1. A processor comprising:
(a) a plurality of processor-cores; and
(b) a controller which divides a program into a plurality of sub-programs, and transfers each of said sub-programs to each of said processor-cores one by one at a predetermined time-interval.

2. The processor as set forth in claim 1, further comprising a direct access memory (DMA) controller which controls data transfer to said processor-cores, and wherein each of said processor-cores includes a memory through which each of said sub-programs is received, and said direct access memory controller transfers each of said sub-programs to said memory in accordance with a control carried out by said controller.

3. The processor as set forth in claim 2, further comprising:
(a) a first interface which makes communication with an external time division multiplexer (TDM);
(b) a second interface which makes communication with an external memory; and
(c) a third interface which makes communication with an external host central processing unit.

4. The processor as set forth in claim 3, further comprising a program-receiver to which said program is transferred from said external memory.

5. The processor as set forth in claim 1, wherein said processor comprises a data signal processor (DSP).

6. The processor as set forth in claim 1, wherein said program is a program for processing aural signals or a program for processing image signals.

7. The processor as set forth in claim 1, wherein said controller transfers each of said sub-programs to each of said processor-cores one by one at the same time-interval.

8. A method of transferring a program into a plurality of processor-cores in a processor, comprising the steps of:
(a) dividing said program into a plurality of sub-programs; and
(b) transferring each of said sub-programs to each of said processor-cores one by one at a predetermined time-interval.

9. The method as set forth in claim 8, further comprising the step of receiving said program from an external memory.

10. The method as set forth in claim 8, wherein said program is a program for processing aural signals or a program for processing image signals.

11. The method as set forth in claim 8, wherein each of said sub-programs is transferred to each of said processor-cores one by one at the same time-interval in said step (b).

12. A program for causing a computer to carry out a method of transferring a program into a plurality of processor-cores in a processor, said method comprising the steps of:
(a) dividing said program into a plurality of sub-programs; and
(b) transferring each of said sub-programs to each of said processor-cores one by one at a predetermined time-interval.

13. The program as set forth in claim 12, wherein each of said sub-programs is transferred to each of said processor-cores one by one at the same time-interval in said step (b).

14. A program for causing a computer as a processor, said processor comprising:
(a) a plurality of processor-cores; and
(b) a controller which divides a program into a plurality of sub-programs, and transfers each of said sub-programs to each of said processor-cores one by one at a predetermined time-interval.

15. The program as set forth in claim 14, wherein said processor further includes a direct access memory (DMA) controller which controls data transfer to said processor-cores, and wherein each of said processor-cores includes a memory through which each of said sub-programs is received, and said direct access memory controller transfers each of said sub-programs to said memory in accordance with a control carried out by said controller.

16. The program as set forth in claim 14, wherein said controller transfers each of said sub-programs to each of said processor-cores one by one at the same time-interval.
